(19) United States
(12) Patent Application Publication
(10) Pub. No.: US 2023/0296887 A1
(43) Pub. Date: Sep. 21, 2023

(54) MICROLENSES PROVIDING WIDE RANGE CHIEF RAY ANGLE MANIPULATION FOR A PANEL DISPLAY

(71) Applicant: Microsoft Technology Licensing, LLC, Redmond, WA (US)

(72) Inventors: Xuzhou LI, Los Altos, CA (US); FEI CHEN, Woodinville, WA (US); Ruipeng SUN, Pleasanton, CA (US)

(21) Appl. No.: 17/698,863

(22) Filed: Mar. 18, 2022

(51) Int. Cl. G02B 27/01; G06T 19/00; G02B 3/00

(52) U.S. Cl. CPC G02B 27/0101; G06T 19/006; G02B 3/0037

(57) ABSTRACT

An emissive panel display comprising an array of microLEDs for producing pixels for images in a projection display system is configured with an array of microlenses in which each microlens in the array corresponds to a respective pixel on the panel display. The configuration of the microlenses varies based on their distance in the plane of the panel display from a central projected axis. Microlenses may be configured with surfaces that are optimized to improve optical efficiency. To improve display illumination uniformity, a microlens may be configured to manipulate the emission angular profile for a given pixel over a wide range to match its chief ray angle (CRA), in which the chief ray for the pixel passes through a center of an entrance pupil of projection optics in the display system.

### BACKGROUND

Light emitting diodes (LEDs) convert electrical energy into optical energy and are utilized as sources of light for images in a wide variety of display devices. Miniature microLEDs are currently available having a small size, light weight, and high brightness and packaging density. Such characteristics may make microLEDs particularly suitable for display systems utilized in head-mounted display (HMD) devices for which high resolution, small form factor, and light weight are typically desirable.

### SUMMARY

An emissive panel display comprising an array of microLEDs for producing pixels for images in a projection display system is configured with an array of microlenses in which each microlens in the array corresponds to a respective pixel on the panel display. The configuration of the microlenses varies based on their distance in the plane of the panel display from a central projected axis. Microlenses may be configured with surfaces that are optimized to improve optical efficiency. To improve display illumination uniformity, a microlens may be configured to manipulate the emission angular profile for a given pixel over a wide range to match its chief ray angle (CRA), in which the chief ray for the pixel passes through a center of an entrance pupil of projection optics in the display system.

Microlenses having two different configurations may be utilized to shape light for on-axial pixels that are nearer to the central axis relative to more distant off-axial pixels—these include circular symmetric surface (e.g., even aspherical surfaces) and asymmetric freeform lens surface. For off-axial pixels, the microlens configurations include an asymmetric freeform lens surface that is tilted to collimate light rays to match the CRA. The circular symmetrical and asymmetric freeform microlens shapes may also each be combined with use of a spatial offset between the microlens and a respective corresponding pixel (i.e., the microlens and pixel are non-coaxial) to provide further light ray manipulation for CRA matching.

In various illustrative embodiments, the panel display comprising the respective arrays of microLEDs and corresponding microlenses is used in a virtual-reality head-mounted display (HMD) device to display images of objects and scenes from a virtual world. HMD devices with the panel display may also be suitably adapted to support mixed-reality environments in which a virtual environment has real-world objects mixed in, or a real-world environment that has virtual objects mixed in.

Advantageously, the panel display comprising the respective arrays of microLEDs and corresponding microlenses provides improvements in optical efficiency and illumination uniformity for the projection display system. Improved optical efficiency enables power to be conserved which is beneficial to many HMD device designs, particularly those that are battery-powered. Improved illumination uniformity provides for a more satisfying and immersive HMD device user experience as the display has even brightness with minimum dark spots across the entire field of view. In addition, the wide range CRA manipulation enabled by the present microlens configurations can provide more design freedom for downstream components such as projection optics in the display system. For example, the optical projection system may be made more compact to reduce HMD device size and weight using the present microlens array.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### DESCRIPTION OF THE DRAWINGS

FIG. 1 shows a pictorial partially cutaway view of an illustrative head-mounted display (HMD) device that is configured with the present microlenses providing wide range chief ray angle manipulation for a panel display;

FIG. 2 illustratively shows virtual images that are overlayed onto real-world images within a field of view (FOV) of a mixed-reality head-mounted display (HMD) device;

FIGS. 3A and 3B show illustrative components of a display device that may be utilized in an HMD device;

FIG. 4 is a pictorial partial view of an illustrative panel display that comprises an array of microLEDs over which an array of microlenses is disposed;

FIG. 5 shows components of an illustrative RGB (red, green, blue) pixel that is produced by an array of three microLEDs to provide individual colored subpixels;

FIG. 6 shows a cone angle for light emission from an illustrative microLED;

FIG. 7 shows a chief ray angle for light rays forming pixels provided by a panel display that propagate in illustrative projection optics;

FIGS. 8A-E show different illustrative configurations for microlenses arranged in accordance with the present principles;

FIG. 9 shows an illustrative distribution of different microlens configurations in an exemplary panel display;

FIG. 10 is a graph showing variation in optical efficiency versus chief ray angle for an illustrative panel display;

FIG. 11 is a flowchart of an illustrative method for operating an optical display system to display virtual images within a field of view of an HMD device;

FIG. 12 shows a pictorial front view of an illustrative sealed visor that may be used as a component of an HMD device;

FIG. 13 shows a pictorial rear view of an illustrative sealed visor;

FIG. 14 shows a partially disassembled view of an illustrative sealed visor;

FIG. 15 shows an illustrative arrangement of diffractive optical elements (DOEs) configured for in-coupling, exit pupil expansion in two directions, and out-coupling;

FIG. 16 shows a simplified side view of an illustrative virtual display system that includes a waveguide-based optical combiner that may be used in an HMD device;

FIG. 17 is a pictorial view of an illustrative example of a virtual-reality or mixed-reality HMD device that may use the present microlenses providing wide range chief ray angle manipulation for a panel display;

FIG. 18 shows a block diagram of an illustrative example of a virtual-reality or mixed-reality HMD device that may use the present microlenses providing wide range chief ray angle manipulation for a panel display; and

FIG. 19 schematically shows an illustrative example of a computing system that may use the present microlenses providing wide range chief ray angle manipulation for a panel display.

Like reference numerals indicate like elements in the drawings. Elements are not drawn to scale unless otherwise indicated.

### DETAILED DESCRIPTION

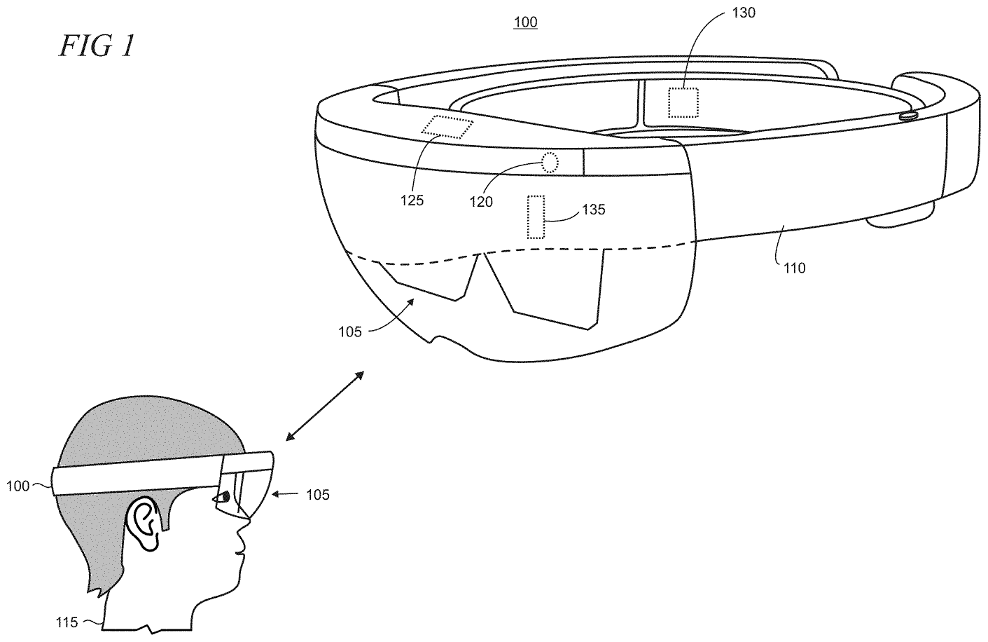

FIG. 1 shows a pictorial partially cutaway view of an illustrative HMD device 100 that is configured with the present microlenses providing wide range chief ray angle manipulation for a panel display. In this example, the HMD device includes a display device 105 and a frame 110 that wraps around the head of a user 115 to position the display device near the user's eyes to provide a virtual-reality or mixed-reality experience to the user.

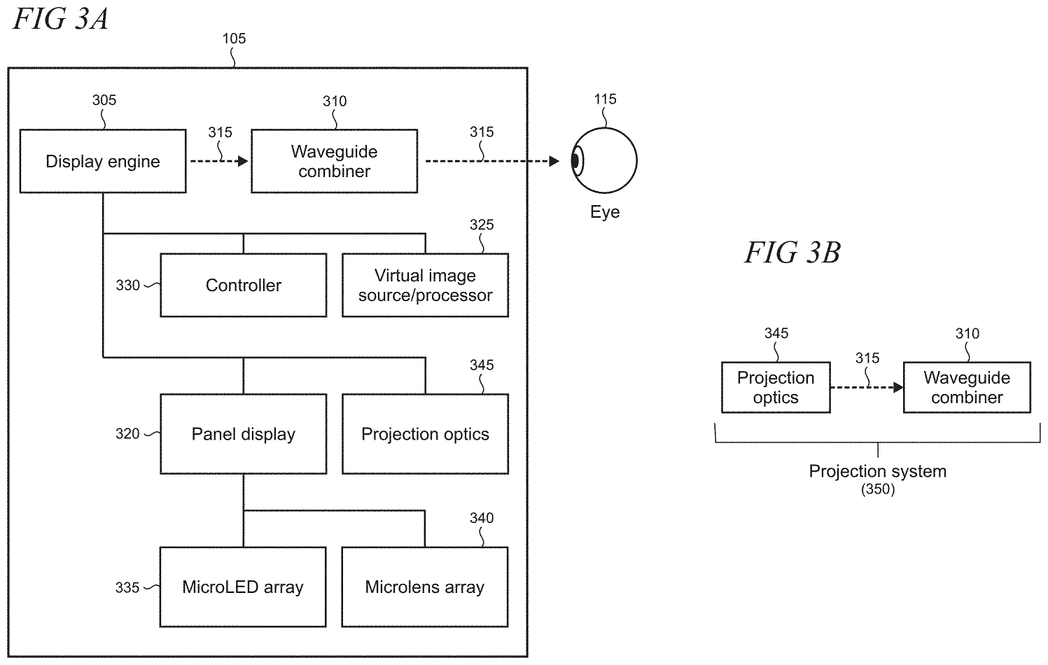

As described further below in the text below accompanying FIGS. 3-6, the display device 105 may include a light-emitting diode (LED) panel display which may be utilized, for example, with a suitable projection system. In alternative implementations, a direct-view eyepiece may be utilized. For a virtual-reality experience, the display device may be opaque. In some implementations, outward facing cameras 120 may be provided that capture images of the surrounding physical environment, and these captured images may be rendered on the display device 105 along with computer-generated virtual images that augment the captured images of the physical environment. For a mixed-reality experience, the display device 105 may further include a see-through optical combiner so that the user of the HMD device 100 can view physical, real-world objects in the physical environment over which pixels for virtual objects are overlayed and/or combined.

The frame 110 may further support additional components of the HMD device 100, including a processor 125, an inertial measurement unit (IMU) 130, and an eye tracker 135. The processor may include logic and associated computer memory configured to receive sensory signals from the IMU and other sensors, to provide display signals to the display device 105, to derive information from collected data, and to enact various control processes described herein.

The display device 105 may be arranged in some implementations as a near-eye display. In a near-eye display the imager does not actually shine the images on a surface such as a glass lens to create the display for the user. This is not feasible because the human eye cannot focus on something that is that close. Rather than create a visible image on a surface, the near-eye display uses an optical system to form a pupil and the user's eye acts as the last element in the optical chain and converts the light from the pupil into an image on the eye's retina as a virtual display. It may be appreciated that the exit pupil is a virtual aperture in an optical system. Only rays which pass through this virtual aperture can exit the system. Thus, the exit pupil describes a minimum diameter of the virtual image light after leaving the display system. The exit pupil defines the eyebox which comprises a spatial range of eye positions of the user in which the virtual images projected by the display device are visible.

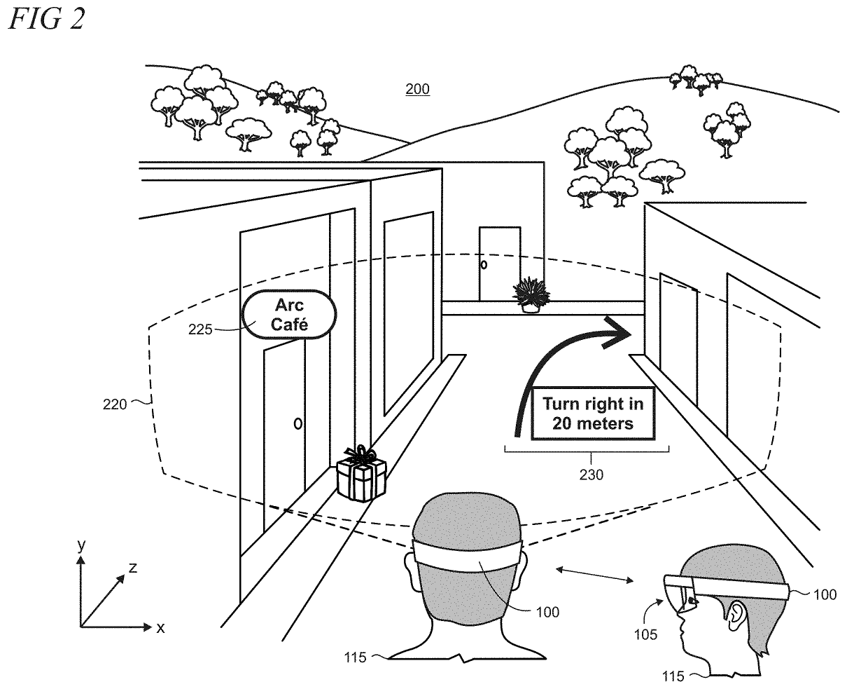

FIG. 2 shows the HMD device 100 worn by a user 115 as configured for mixed-reality experiences in which the display device 105 is configured as a near-eye display system having at least a partially transparent, see-through waveguide, among various other components. As noted above, a suitable display engine (not shown) generates virtual images that are guided by the waveguide in the display device to the user. Being see-through, the waveguide in the display device enables the user to perceive light from the real world.

The see-through waveguide-based display device 105 can render images of various virtual objects that are superimposed over the real-world images that are collectively viewed using the see-through waveguide display to thereby create a mixed-reality environment 200 within the HMD device's FOV (field of view) 220. It is noted that the FOV of the real world and the FOV of the images in the virtual world are not necessarily identical, as the virtual FOV provided by the display device is typically a subset of the real FOV. FOV is typically described as an angular parameter in horizontal, vertical, or diagonal dimensions.

It is noted that FOV is just one of many parameters that are typically considered and balanced by HMD device designers to meet the requirements of a particular implementation. For example, such parameters may include eyebox size, brightness, transparency and duty time, contrast, resolution, color fidelity, depth perception, size, weight, form-factor, and user comfort (i.e., wearable, visual, and social), among others.

In the illustrative example shown in FIG. 2, the user 115 is physically walking in a real-world urban area that includes city streets with various buildings, stores, etc., with a countryside in the distance. The FOV of the cityscape viewed on HMD device 100 changes as the user moves through the real-world environment and the device can render static and/or dynamic virtual images over the real-world view. In this illustrative example, the virtual images include a tag 225 that identifies a restaurant business and directions 230 to a place of interest in the city. The mixed-reality environment 200 seen visually on the waveguide-based display device may also be supplemented by audio and/or tactile/haptic sensations produced by the HMD device in some implementations.

FIG. 3A shows illustrative components of the display device 105 that may be utilized in the HMD device in an illustrative mixed-reality embodiment. The display device includes a display engine 305 and a waveguide combiner 310 to provide virtual and real images to the user 115 over a light path 315.

As shown, the display engine 305 may include a panel display 320 that is arranged to provide a display of virtual images from a source or image processor 325 to the waveguide combiner 310 responsively to instructions from a controller 330. The panel display 320 in this illustrative example comprises a microLED array 335 and a microlens array 340 which are further described below.

Projection optics 345 may be utilized to shape the virtual images, as needed, to support an optical interface between the display engine and the waveguide combiner. The projection optics and waveguide combiner may be referred to collectively as a projection system 350, as shown in FIG. 3B, as such components are arranged to project the virtual images from the panel display for viewing by an HMD device user 115 (FIG. 1). For example, as discussed below, an HMD device may be configured with a near-eye display system in which virtual images are projected on to the retinas of the user.

In an illustrative implementation, a waveguide in the waveguide combiner 310 operates using a principle of total internal reflection (TIR) so that light can be coupled among the various optical elements in the HMD device 100 (FIG. 1). TIR is a phenomenon which occurs when a propagating light wave strikes a medium boundary (e.g., as provided by the optical substrate of a waveguide or prism) at an angle larger than the critical angle with respect to the normal to the surface. In other words, the critical angle (θ_{c}) is the angle of incidence above which TIR occurs, which is given by Snell's Law, as is known in the art. More specifically, Snell's law states that the critical angle (θ_{c}) is specified using the following equation:

θ_{c}=sin⁻¹(n2/n1)

where θ_{c} is the critical angle for two optical mediums (e.g., the waveguide substrate and air or some other medium that is adjacent to the substrate) that meet at a medium boundary, n1 is the index of refraction of the optical medium in which light is traveling towards the medium boundary (e.g., the waveguide substrate, once the light is coupled therein), and n2 is the index of refraction of the optical medium beyond the medium boundary (e.g., air or some other medium adjacent to the waveguide substrate).

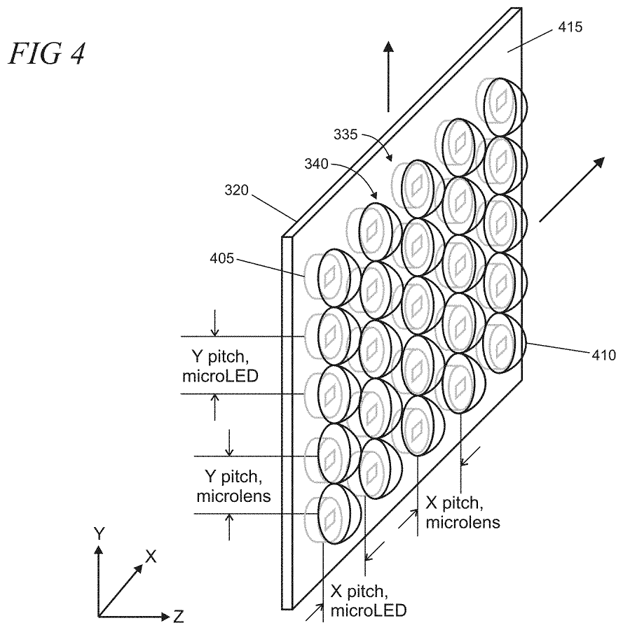

FIG. 4 shows a pictorial view of a portion of the panel display 320 that extends in both the X and Y directions, as shown, to provide a number of display pixels that is suitable for a given application. The microLED array 335 comprises a two-dimensional distribution of individual microLEDs (representatively indicated by reference numeral 405) each comprising a die that functions as a source element for pixels in the display. The microlens array 340 is arranged to provide an individual microlens (representatively indicated by reference numeral 410) that corresponds to a respective microLED to direct, shape, or manipulate light rays emitted therefrom, as further discussed below.

In an illustrative example, the microLEDs may include epitaxial structures fabricated on a substrate 415 in a grid comprising rows extending along the X axis and columns along the Y axis. The microLED array 335 and microlens array 340 may be characterized by pitches in the X and Y directions. The pitches may be of equal or non-equal values and microLEDs in rows and columns can include a rectangular, staggered (i.e., non-adjacent dies), or other suitable geometric distribution. The microLEDs in the array may be sparsely or densely packed as appropriate to balance, for example, cross-talk and form-factor compactness of the microLED array, or other design parameters for a given application.

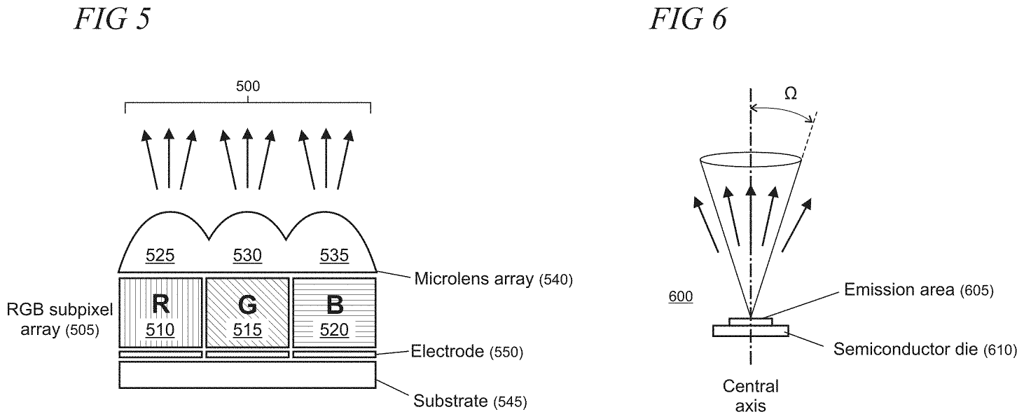

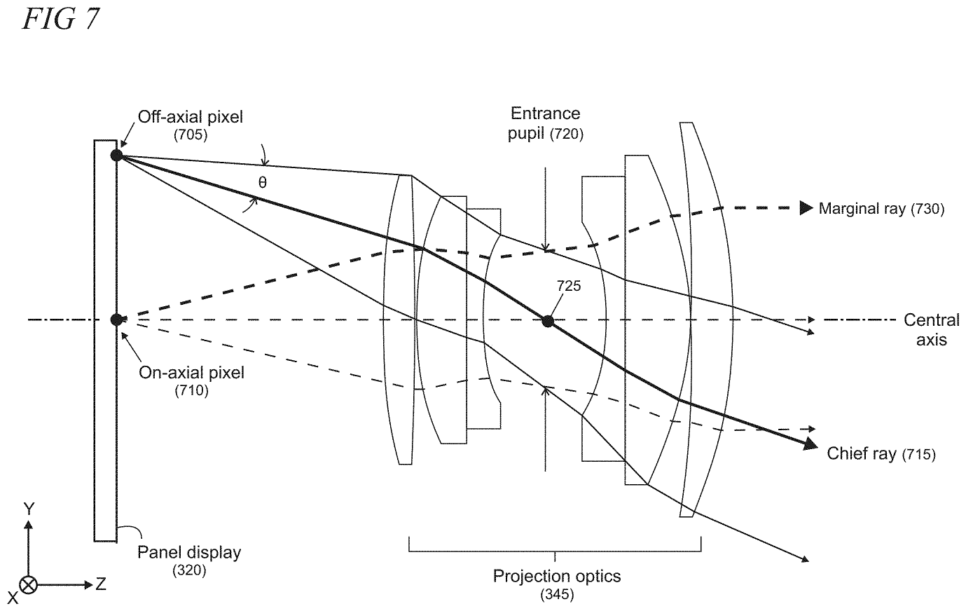

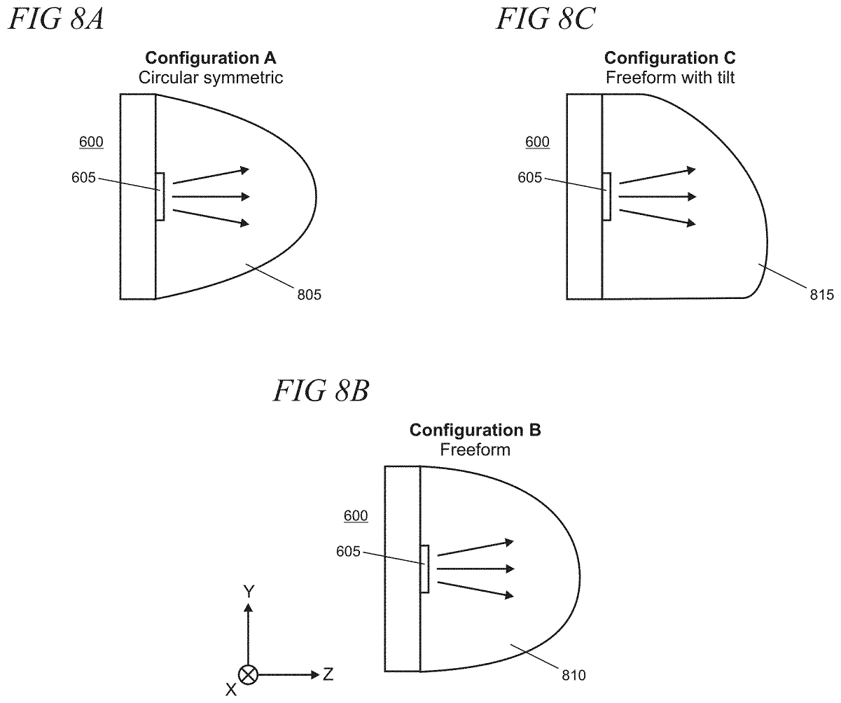

In various HMD device applications, the panel display 320 may be configured as a monochromatic or multicolor display. FIG. 5 shows components of an illustrative RGB (red, green, blue) pixel 500 that is produced by an array 505 of three microLEDs that provide individual colored subpixels 510, 515, and 520 according to an RGB color model. The RGB color model is illustrative, and other color models and a corresponding number of subpixels and colors may also be utilized. In addition, the present principles may also be applied to applications using non-visible light, such as infrared light.

As shown, individual microlenses 525, 530, and 535 are utilized in a microlens array 540 for each respective corresponding microLED 510, 515, and 520 in the array, it may be appreciated that the term “pixel” as used herein refers to monochromatic light emissions generated by an individual microLED. However, the term may also be used to refer to the constituent elements of a color display of virtual images in general. depending on the context of the particular usage.

A microLED comprises a semiconductor made from inorganic emissive materials to provide an active emitting layer among multiple layers of semiconducting layers that are disposed on a substrate 545. In alternative implementations, a microLED may be substrateless to reduce thickness. A metal layer is disposed in the semiconductor to provide an electrode (representatively indicated by reference numeral 550) carrying electrical energy for each subpixel in the array 505. While definitions can vary by supplier and usage environment, typically a microLED is up to about 100 microns in size (i.e., per side or diameter) and may be under 50 microns in some cases.

A conventional miniLED, by contrast, may be defined as having a side length or diameter that is greater than 100 microns and is typically significantly thicker than a microLED which can be fabricated to be extremely thin. While a microLED array is utilized in the present illustrative example, it may be appreciated that the present principles may also be applied to other types of emissive panel display using various technologies including, for example, miniLEDs, organic LEDs (OLEDs), quantum-dot light-emitting diode (QLED), or other suitable emissive sources, individually or in combination.

FIG. 6 shows a cone angle Q for light emission from an illustrative microLED 600 that is arranged, for example, to emit monochromatic light for a pixel or subpixel in the panel display 320 (FIG. 3). The emission area 605 of a semiconductor die 610 in the microLED may take various shapes including, for example, rectangular, circular, hexagonal, etc., to meet the requirements of a given application. Not all of the light emitted from the emission area is typically effective for panel display illumination. For example, for projection-based display devices, only light rays emitted within a cone angle Ω=±10-15 degrees are able to be effectively propagated through the downstream projection system (e.g., the projection optics 345 and combiner 310 shown in FIG. 3 and discussed in the accompanying text).

Light from a broad angle emitter will thus be lost which results in reduced optical efficiency for the display system. Accordingly, in accordance with present principles, the microlens array is arranged to collimate light for each pixel source in the panel display into the central cone angle to maximize optical efficiency. Such optimization can save energy which is typically an important design consideration in battery-powered equipment such as HMD devices.

FIG. 7 shows a chief ray angle θ for light rays forming pixels provided by the panel display 320 that propagate in an illustrative optical projection system. Illustrative pixels include an off-axial pixel 705 and an on-axial pixel 710 with reference to a central axis of the panel display and projection optics 345. It may be appreciated that the panel display and projection optics have a co-axial or telecentric configuration in this illustrative example. However, non-telecentric configurations may also be used in alternative embodiments that utilize the present principles.

The chief ray angle (CRA) describes an angle of a chief ray 715 traced between a point on the panel display 320 for the off-axial pixel 705 and the center of the entrance pupil of the projection optics 345. The entrance pupil is indicated by reference numeral 720 and the center point by reference numeral 725 in the drawing. As shown, a marginal ray 730 passes from the on-axial pixel 710 at the center of the panel display to the maximum aperture of the entrance pupil.

In projection systems, only light closest to the chief ray is able to be collected and used to deliver virtual images to the eyes of a user. Thus, the optical efficiency of the system changes based on pixel location in the display which causes non-uniformities in the brightness of the panel display which can be manifested as dark areas at various locations within the FOV of the system, particularly at the edges and corners of the display where the CRA is largest. This problem can be exacerbated by some projection system architectures, particularly those that have compact form factors, as the CRA can be expected to be even larger in such systems.

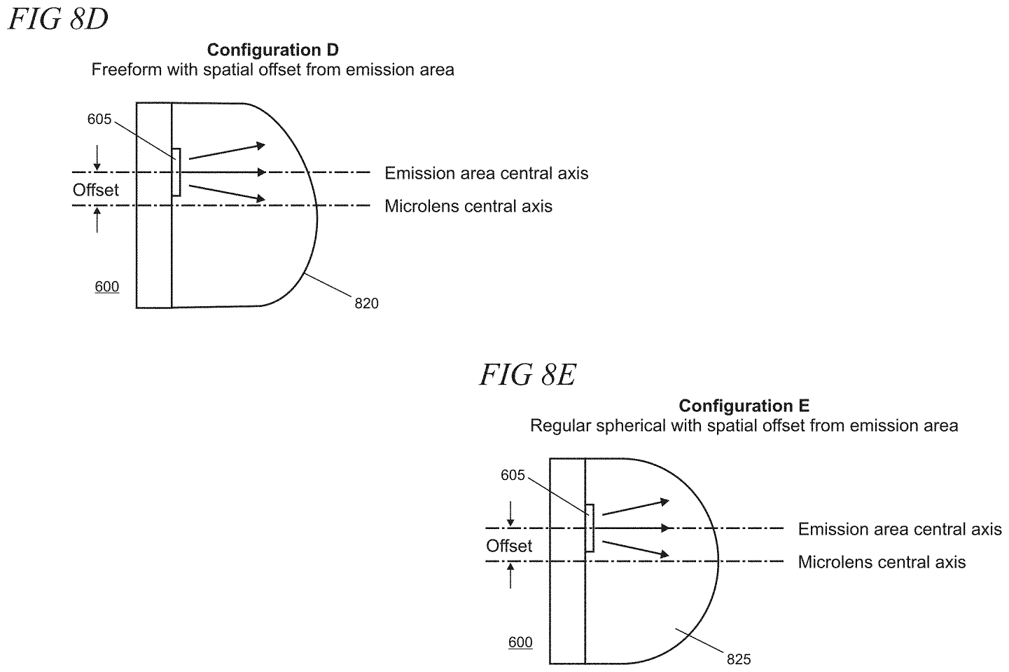

FIGS. 8A-E show different illustrative configurations for microlenses arranged in accordance with the present principles that are disposed over an exemplary microLED 600 to perform manipulation of light rays emitted from the emission area 605. The microlens configurations are adapted to increase optical efficiency of the panel display such that available power is utilized to maximum advantage and also to improve illumination uniformity by CRA manipulation for off-axial pixels in the display.

FIG. 8A shows a first illustrative configuration for a microlens 805 (configuration A) in which a lens surface has a circularly symmetric surface shape. FIG. 8B shows a second illustrative configuration for a microlens 810 (configuration B) that has a freeform lens surface shape. The term “freeform lens surface” as used herein refers to a shape that has no axis of rotational invariance (within or beyond the microlens). Thus, the freeform lens exhibits different properties depending on its rotational position with respect to the central axis of the microLED. Freeform surfaces may be configured to enable optimization of beam shaping by the lens for nearly all incident rays. Aspheric optics may be considered a special case of freeform optics with an axis of rotational invariance. Conventionally, an aspheric surface may have an axis, while freeform surfaces may not. Freeform microlenses may be described, for example, using a direct calculation method based on imaging theory or by an extended polynomial that can approximate the surface shape.

FIG. 8C shows a third illustrative configuration for a microlens 815 (configuration C) that has a freeform lens surface shape. Configuration C may be utilized for light manipulation of off-axial pixels that functions to tilt the microlens surface to match an emitted ray's angle to its CRA.

FIG. 8D shows a fourth illustrative configuration of a microlens 820 (configuration D) that has a freeform lens surface shape that provides the CRA matching for off-axial pixels. In addition, configuration D utilizes a non-coaxial spatial relationship in which the emission area 605 of the microLED 600 is offset in the plane of the array (i.e., the XY plane shown in FIG. 4) from the centerline of the microlens. FIG. 8E shows a fifth illustrative configuration of a microlens 825 (configuration E) that has a regular spherical surface shape and in which an offset is utilized between the emission area of the microLED and the centerline of the microlens.

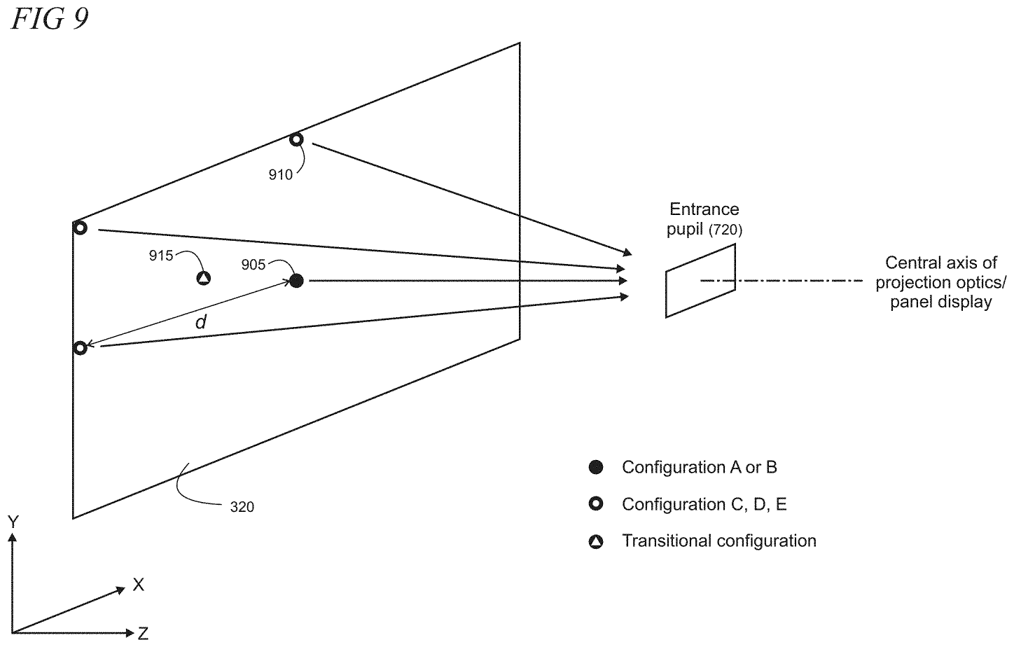

FIG. 9 shows an illustrative distribution of different microlens configurations that may be deployed in the panel display 320. The particular microlens configuration that is used for a given pixel may be dependent on its distance d from the central axis of the panel display in the XY plane. For on-axial pixels on the display nearer to the central axis (representatively indicated by reference numeral 905), for example, microlens configuration A or B having circularly symmetric and freeform surfaces, respectively, may be advantageously utilized.

For off-axial pixels (representatively indicated by reference numeral 910), either configuration C or D, freeform and freeform with spatial offset, respectively, may be advantageously utilized to manipulate rays emitted from the panel towards the entrance pupil 720 of the projection optics to match their respective CRA. Thus, for example, a given panel display may utilize one or more of the microlens configurations shown in FIG. 8 and described in the accompanying text. For pixels in the display that are in between the central and extreme off-axial locations, a smooth transition may be implemented between configuration types by implementing similar lens surface shapes and then applying varying spatial offsets that are calculated using linear interpolation between microlenses that are proximate and distal to a central axis of the microlens array which are corresponding to on-axial and off-axial pixels of the panel display. Alternatively, the microlens array 340 (FIG. 3) can be divided into a plurality of ring regions that are co-axial with the central axis of the display. A freeform surface shape for microlenses in each region of the array can be configured to manipulate the chief ray angle for their respective corresponding pixels in accordance with the present principles disclosed herein.

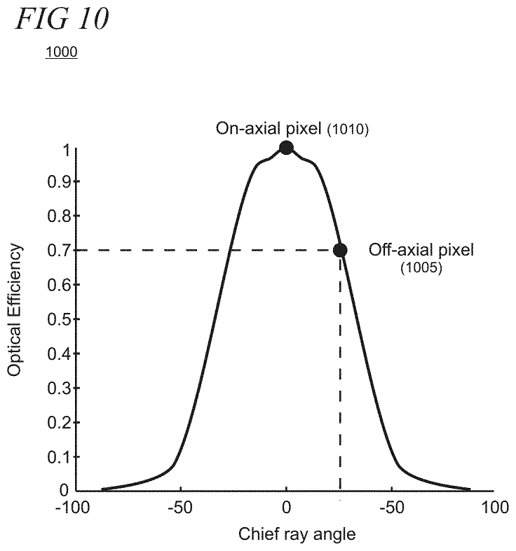

FIG. 10 is a graph 1000 showing variation in normalized optical efficiency versus CRA for the panel display 320 (FIG. 3) configured with microlenses in accordance with the present principles. As shown, a pixel 1005 with a CRA of 20 degrees has an optical efficiency that is about 70% that of a pixel 1010 having a CRA of zero degrees. These results favorably compare with some conventional projection systems in which a 20-degree CRA pixel has only around 28% of the optical efficiency of the zero-degree CRA pixel.

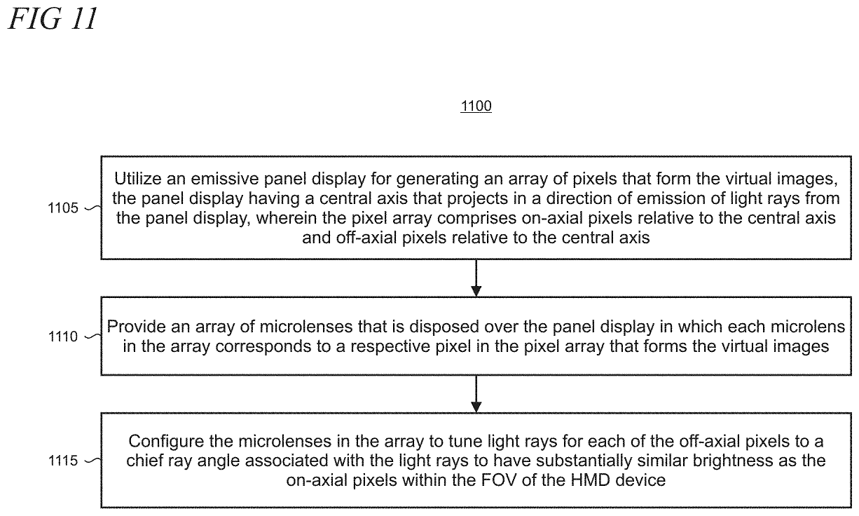

FIG. 11 is a flowchart 1100 of an illustrative method for operating an optical display system to display virtual images within an FOV. Unless specifically stated, the methods or steps shown in the flowchart and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

In block 1105, an emissive panel display is utilized for generating an array of pixels that form the virtual images. The panel display has a central axis that projects in a direction of emission of light rays from the panel display, wherein the pixel array comprises on-axial pixels relative to the central axis and off-axial pixels relative to the central axis. In block 1110, an array of microlenses is provided that is disposed over the panel display in which each microlens in the array corresponds to a respective pixel in the pixel array that forms the virtual images. In block 1115, the microlenses in the array are configured to tune light rays for each of the off-axial pixels to a chief ray angle associated with light rays for the off-axial pixel to have substantially similar brightness as the on-axial pixels within the FOV of the HMD device.

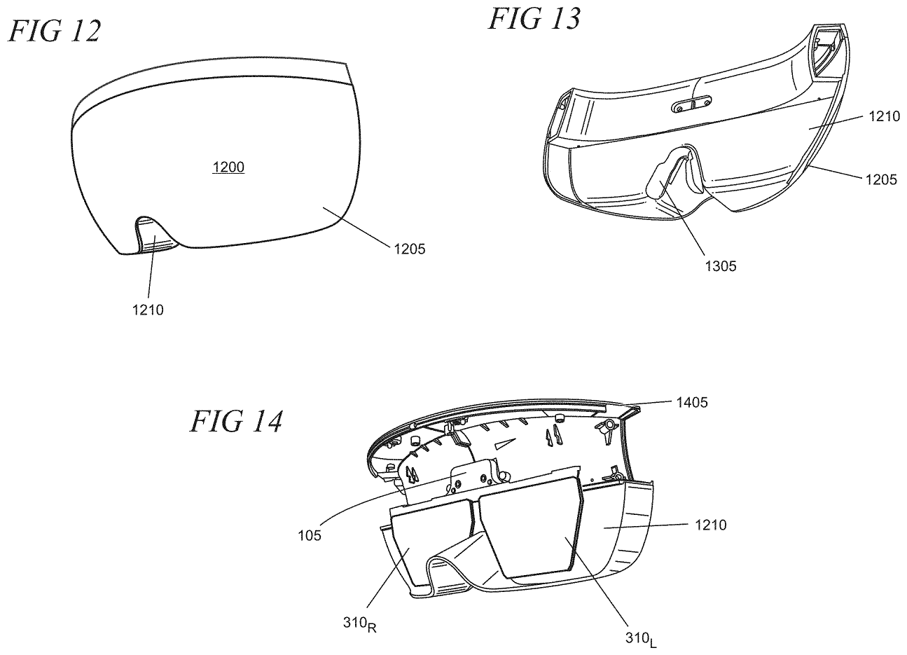

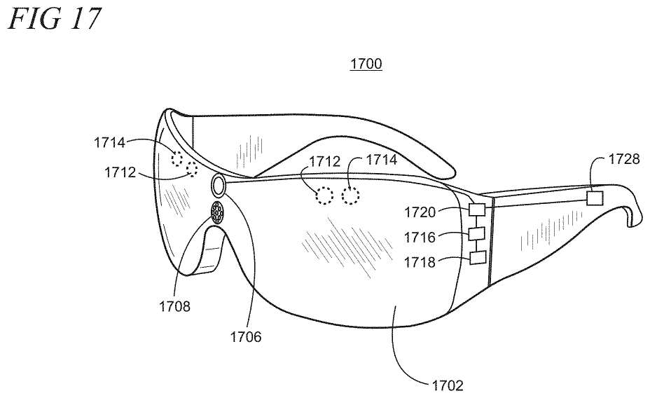

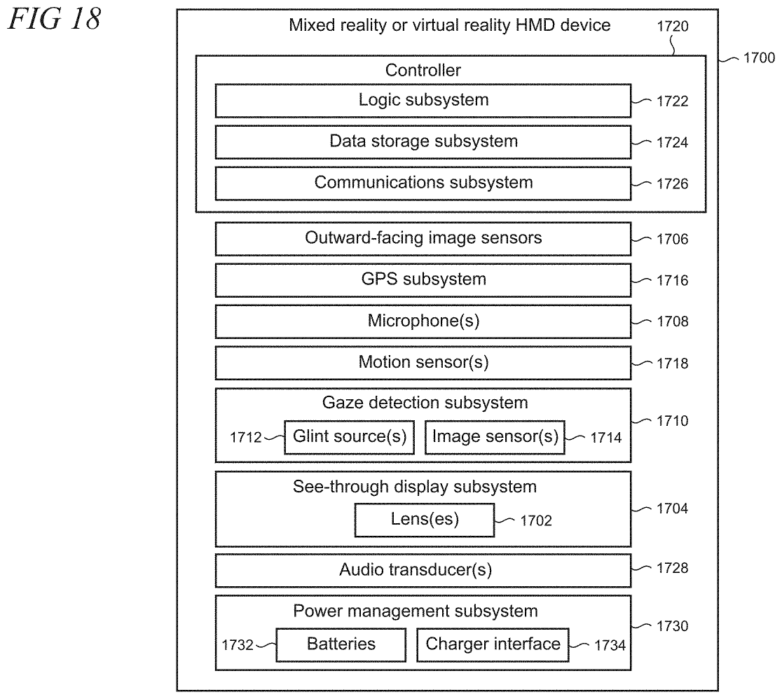

FIGS. 12 and 13 show respective front and rear views of an illustrative example of a visor 1200 that incorporates an internal near-eye display device 105 (FIGS. 1 and 2) that is used in the HMD device 100 as worn by a user 115. The visor, in some implementations, may be sealed to protect the internal display device. The visor typically interfaces with other components of the HMD device such as head-mounting/retention systems and other subsystems including sensors, power management, controllers, etc., as illustratively described in conjunction with FIGS. 17 and 18. Suitable interface elements (not shown) including snaps, bosses, screws, and other fasteners, etc. may also be incorporated into the visor.

The visor 1200 may include see-through front and rear shields, 1205 and 1210 respectively, that can be molded using transparent or partially transparent materials to facilitate unobstructed vision to the display device and the surrounding real-world environment. Treatments may be applied to the front and rear shields such as tinting, mirroring, anti-reflective, anti-fog, and other coatings, and various colors and finishes may also be utilized. The front and rear shields are affixed to a chassis 1405 shown in the disassembled view in FIG. 14.

The sealed visor 1200 can physically protect sensitive internal components, including the display device 105, when the HMD device is operated and during normal handling for cleaning and the like. The display device in this illustrative example includes left and right waveguide combiners 310L and 310R that respectively provide virtual images to the user's left and right eyes for mixed- and/or virtual-reality applications. The visor can also protect the display device from environmental elements and damage should the HMD device be dropped or bumped, impacted, etc.

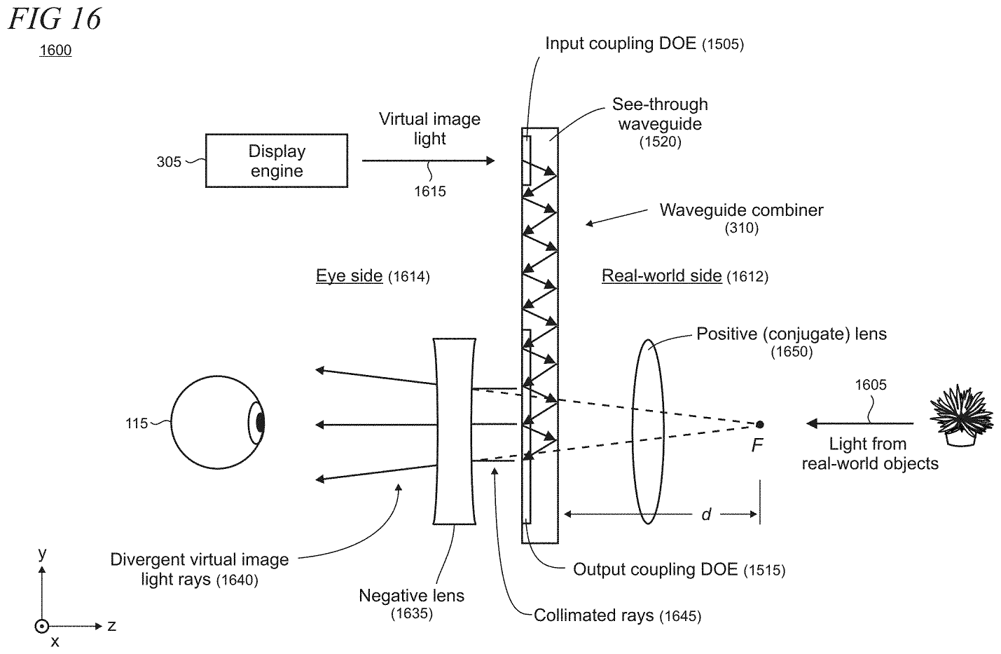

As shown in FIG. 13, the rear shield 1210 is configured in an ergonomically suitable form 1305 to interface with the user's nose, and nose pads and/or other comfort features can be included (e.g., molded-in and/or added-on as discrete components). In some applications, the sealed visor 1210 can also incorporate some level of optical diopter curvature (i.e., eye prescription) within the molded shields in some cases. The sealed visor 1200 can also be configured to incorporate a conjugate lens pair as shown in FIG. 16 and described in the accompanying text.

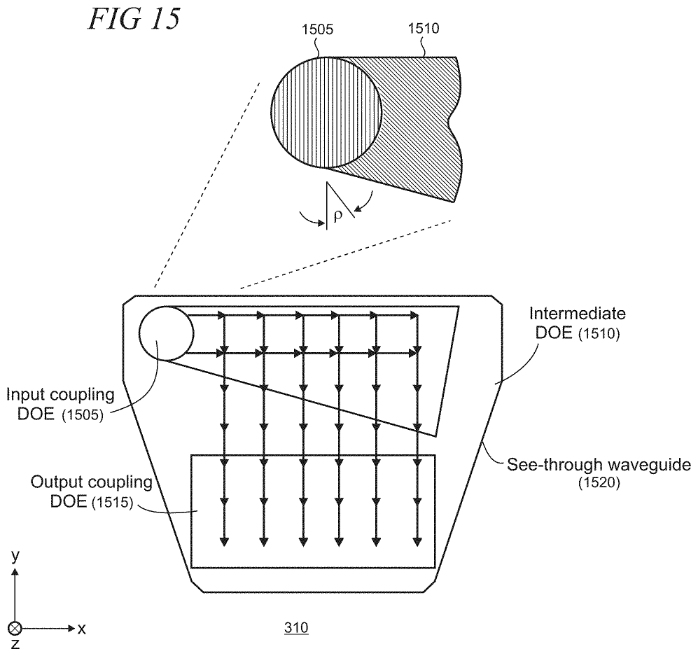

FIG. 15 shows an illustrative waveguide combiner 310 having multiple diffractive optical elements (DOEs) that may be used in an embodiment of the display device 105 (FIG. 1) to provide input coupling, expansion of the exit pupil in two directions, and output coupling of virtual images from the display engine 305 (FIG. 3) to the user's eye. Each DOE is an optical element comprising a periodic structure that can modulate various properties of light in a periodic pattern such as the direction of optical axis, optical path length, and the like. The structure can be periodic in one dimension such as one-dimensional (1D) grating and/or be periodic in two dimensions such as two-dimensional (2D) grating. DOEs may comprise, for example, surface relief grating (SRG) structures and volumetric holographic grating (VHG) structures.

The waveguide combiner 310 includes input and output couplers, which may comprise an input coupling DOE 1505 and an output coupling DOE 1515. An intermediate DOE 1510 may be provided that couples light between the input coupling and output coupling DOEs. The input coupling DOE is configured to couple image light comprising one or more imaging beams from the display engine into the waveguide 1520. The intermediate DOE expands the exit pupil in a first direction along a first coordinate axis (e.g., horizontal), and the output coupling DOE expands the exit pupil in a second direction along a second coordinate axis (e.g., vertical) and couples light out of the waveguide to the user's eye (i.e., outwards from the plane of the drawing page). The angle ρ is a rotation angle between the periodic lines of the input coupling DOE and the intermediate DOE as shown. As the light propagates in the intermediate DOE (horizontally from left to right in the drawing), it is also diffracted (in the downward direction) to the output coupling DOE.

While DOEs are shown in this illustrative example using a single input coupling DOE disposed to the left of the intermediate DOE 1510, which is located above the output coupling DOE, in some implementations, the input coupling DOE may be centrally positioned within the waveguide and one or more intermediate DOEs can be disposed laterally from the input coupling DOE to enable light to propagate to the left and right while providing for exit pupil expansion along the first direction. It may be appreciated that other numbers and arrangements of DOEs may be utilized to meet the needs of a particular implementation. In other implementations of the present microlenses providing wide range chief ray angle manipulation for a panel display, optical components operating in reflection may be utilized for one or more of input coupler, intermediate coupler, or output coupler.

FIG. 16 shows a simplified side view of an illustrative virtual display system 1600 that is incorporated into the display device 105 (FIG. 1) and which may be used in the HMD device 100 to render virtual images. The virtual display system may function as an optical combiner by superimposing the rendered virtual images over the user's view of light from real-world objects 1605 to thus form the mixed-reality display.

The display system includes at least one partially transparent (i.e., see-through) waveguide 1520 that is configured to propagate visible light. While a single waveguide is shown in FIG. 16 for sake of clarity in exposition of the present principles, it will be appreciated that a plurality of waveguides may be utilized in some applications. For example, three waveguides may be utilized in which a single waveguide supports each color component in an RGB (red, green, blue) color space.

The waveguide 1520 facilitates light transmission between the virtual image source and the eye. One or more waveguides can be utilized in the near-eye display system because they are transparent and because they are generally small and lightweight. This is desirable in applications such as HMD devices where size and weight are generally sought to be minimized for reasons of performance and user comfort. Use of the waveguide 1520 can enable the virtual image source to be located out of the way, for example, on the side of the user's head or near the forehead, leaving only a relatively small, light, and transparent waveguide optical element in front of the eyes.

The user 115 can look through the waveguide 1520 to see real-world objects on the real-world side of the display device 105 (the real-world side is indicated by reference numeral 1612 in FIG. 16). For the virtual part of the FOV of the display system, virtual image light 1615 is provided by the display engine 305. The virtual image light is in-coupled to the waveguide by an input coupling DOE 1505 and propagated through the waveguide in total internal reflection. The image light is out-coupled from the waveguide by an output coupling DOE 1515. The combination of the see-through waveguide and coupling elements may be referred to as a mixed-reality optical combiner because it functions to combine real-world and virtual-world images into a single display.

Typically, in such waveguide-based optical combiners, the input pupil needs to be formed over a collimated field, otherwise each waveguide exit pupil will produce an image at a slightly different distance. This results in a mixed visual experience in which images are overlapping with different focal depths in an optical phenomenon known as focus spread. The collimated inputs and outputs in conventional waveguide-based display systems provide virtual images displayed by the display device that are focused at infinity.

In alternative embodiments, the optical combiner functionality provided by the waveguide and DOEs may be implemented using a reflective waveguide combiner. For example, partially reflective surfaces may be embedded in a waveguide and/or stacked in a geometric array to implement an optical combiner that uses partial field propagation. The reflectors can be half-tone, dielectric, holographic, polarized thin layer, or be fractured into a Fresnel element.

In other embodiments, the principles of the present microlenses providing wide range chief ray angle manipulation for a panel display may be implemented using a reflective waveguide combiner having wavelength-sensitive reflective coatings with any suitable in-coupling and/or out-coupling methods. A reflective waveguide combiner may utilize a single waveguide in some implementations for all colors in the virtual images which may be desirable in some applications. By comparison, diffractive combiners typically require multiple waveguides to meet a target FOV in polychromatic applications due to limitations on angular range that are dictated by the waveguide TIR condition.

The present microlenses providing wide range chief ray angle manipulation for a panel display may also be utilized with various other waveguide/coupling configurations beyond reflective and diffractive. For example, it may be appreciated that the principles of the present invention may be alternatively applied to waveguides that are refractive, polarized, hybrid diffractive/refractive, phase multiplexed holographic, and/or achromatic metasurfaces.

A negative lens 1635 is located on the eye side of the waveguide 1520 (the eye side is indicated by reference numeral 1614 in FIG. 16). The negative lens acts over the entire extent of the eyebox associated with the user's eye to thereby create the diverging rays 1640 from the collimated rays 1645 that exit the output coupling DOE 1515. When the display engine 305 is operated to project virtual images that are in-coupled into the waveguide 1520, the output diverging rays present the virtual images at a predetermined focal depth, d, from the display system at an apparent or virtual point of focus, F. For example, if the negative lens is configured with −0.5 diopters of optical power, then d is equal to 2 m.

To ensure that the user's view of the real world remains unperturbed by the negative lens, a conjugate positive (i.e., convex) lens 1650 is located on the real-world side of the waveguide 1520 to compensate for the impact of the negative lens on the eye side. The conjugate pair of positive and negative lenses may be referred to as a push-pull lens pair in some contexts. In some applications, the functionality of the negative lens may be provided by a discrete standalone optical element. In other applications, one or more of the elements in the display device may be configured to incorporate the negative lens as an additional functionality. For example, the negative lens functionality can be integrated into the output coupler and/or waveguide in the display device using any suitable technique.

Different amounts of optical power may be utilized to provide for focal planes that are located at other distances to suit requirements of a particular application. The power of the negative lens 1635 does not affect the zeroth diffraction order that travels in TIR down the waveguide 1520 (i.e., from top to bottom in the drawings), but instead only affects the diffracted out-coupled field. In addition, the see-through field is not affected by the negative lens because whatever portion of the see-through field that is diffracted by the output coupling DOE 1515 is trapped by TIR in the waveguide and is therefore not transmitted to the user's eye.

As noted above, the present microlenses providing wide range chief ray angle manipulation for a panel display may be utilized in mixed- or virtual-reality applications. FIG. 17 shows one particular illustrative example of a mixed-reality HMD device 1700, and FIG. 18 shows a functional block diagram of the device 1700. The HMD device 1700 provides an alternative form factor to the HMD device 100 shown in FIGS. 1, 2, and 12-14. HMD device 1700 comprises one or more lenses 1702 that form a part of a see-through display subsystem 1704, so that images may be displayed using lenses 1702 (e.g., using projection onto lenses 1702, one or more waveguide systems, such as a near-eye display system, incorporated into the lenses 1702, and/or in any other suitable manner).

HMD device 1700 further comprises one or more outward-facing image sensors 1706 configured to acquire images of a background scene and/or physical environment being viewed by a user and may include one or more microphones 1708 configured to detect sounds, such as voice commands from a user. Outward-facing image sensors 1706 may include one or more depth sensors and/or one or more two-dimensional image sensors. In alternative arrangements, as noted above, a mixed-reality or virtual-reality display system, instead of incorporating a see-through display subsystem, may display mixed-reality or virtual-reality images through a viewfinder mode for an outward-facing image sensor.

The HMD device 1700 may further include a gaze detection subsystem 1710 configured for detecting a direction of gaze of each eye of a user or a direction or location of focus, as described above. Gaze detection subsystem 1710 may be configured to determine gaze directions of each of a user's eyes in any suitable manner. For example, in the illustrative example shown, a gaze detection subsystem 1710 includes one or more glint sources 1712, such as virtual IR light or visible sources as described above, that are configured to cause a glint of light to reflect from each eyeball of a user, and one or more image sensors 1714, such as inward-facing sensors, that are configured to capture an image of each eyeball of the user. Changes in the glints from the user's eyeballs and/or a location of a user's pupil, as determined from image data gathered using the image sensor(s) 1714, may be used to determine a direction of gaze.

In addition, a location at which gaze lines projected from the user's eyes intersect the external display may be used to determine an object at which the user is gazing (e.g., a displayed virtual object and/or real background object). Gaze detection subsystem 1710 may have any suitable number and arrangement of light sources and image sensors. In some implementations, the gaze detection subsystem 1710 may be omitted.

The HMD device 1700 may also include additional sensors. For example, HMD device 1700 may comprise a global positioning system (GPS) subsystem 1716 to allow a location of the HMD device 1700 to be determined. This may help to identify real-world objects, such as buildings, etc., that may be located in the user's adjoining physical environment.

The HMD device 1700 may further include one or more motion sensors 1718 (e.g., inertial, multi-axis gyroscopic, or acceleration sensors) to detect movement and position/orientation/pose of a user's head when the user is wearing the system as part of a mixed-reality or virtual-reality HMD device. Motion data may be used, potentially along with eye-tracking glint data and outward-facing image data, for gaze detection, as well as for image stabilization to help correct for blur in images from the outward-facing image sensor(s) 1706. The use of motion data may allow changes in gaze direction to be tracked even if image data from outward-facing image sensor(s) 1706 cannot be resolved.

In addition, motion sensors 1718, as well as microphone(s) 1708 and gaze detection subsystem 1710, also may be employed as user input devices, such that a user may interact with the HMD device 1700 via gestures of the eye, neck and/or head, as well as via verbal commands in some cases. It may be understood that sensors illustrated in FIGS. 17 and 18 and described in the accompanying text are included for the purpose of example and are not intended to be limiting in any manner, as any other suitable sensors and/or combination of sensors may be utilized to meet the needs of a particular implementation. For example, biometric sensors (e.g., for detecting heart and respiration rates, blood pressure, brain activity, body temperature, etc.) or environmental sensors (e.g., for detecting temperature, humidity, elevation, UV (ultraviolet) light levels, etc.) may be utilized in some implementations.

The HMD device 1700 can further include a controller 1720 such as one or more processors having a logic subsystem 1722 and a data storage subsystem 1724 in communication with the sensors, gaze detection subsystem 1710, display subsystem 1704, and/or other components through a communications subsystem 1726. The communications subsystem 1726 can also facilitate the display system being operated in conjunction with remotely located resources, such as processing, storage, power, data, and services. That is, in some implementations, an HMD device can be operated as part of a system that can distribute resources and capabilities among different components and subsystems.

The storage subsystem 1724 may include instructions stored thereon that are executable by logic subsystem 1722, for example, to receive and interpret inputs from the sensors, to identify location and movements of a user, to identify real objects using surface reconstruction and other techniques, and dim/fade the display based on distance to objects so as to enable the objects to be seen by the user, among other tasks.

The HMD device 1700 is configured with one or more audio transducers 1728 (e.g., speakers, earphones, etc.) so that audio can be utilized as part of a mixed-reality or virtual-reality experience. A power management subsystem 1730 may include one or more batteries 1732 and/or protection circuit modules (PCMs) and an associated charger interface 1734 and/or remote power interface for supplying power to components in the HMD device 1700.

It may be appreciated that the HMD device 1700 is described for the purpose of example, and thus is not meant to be limiting. It may be further understood that the display device may include additional and/or alternative sensors, cameras, microphones, input devices, output devices, etc. than those shown without departing from the scope of the present arrangement. Additionally, the physical configuration of an HMD device and its various sensors and subcomponents may take a variety of different forms without departing from the scope of the present arrangement.

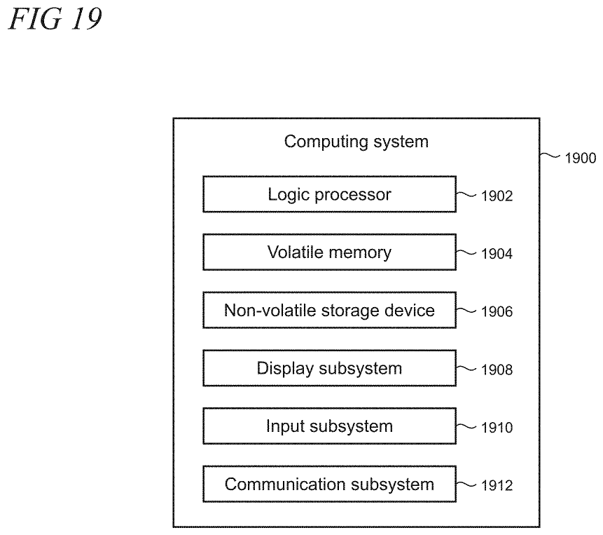

FIG. 19 schematically shows an illustrative example of a computing system 1900 that can enact one or more of the methods and processes described above for the present microlenses providing wide range chief ray angle manipulation for a panel display. Computing system 1900 is shown in simplified form. Computing system 1900 may take the form of one or more personal computers, server computers, tablet computers, home-entertainment computers, network computing devices, gaming devices, mobile computing devices, mobile communication devices (e.g., smartphone), wearable computers, and/or other computing devices.

Computing system 1900 includes a logic processor 1902, volatile memory 1904, and a non-volatile storage device 1906. Computing system 1900 may optionally include a display subsystem 1908, input subsystem 1910, communication subsystem 1912, and/or other components not shown in FIG. 19.

Logic processor 1902 includes one or more physical devices configured to execute instructions. For example, the logic processor may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more processors configured to execute software instructions. In addition, or alternatively, the logic processor may include one or more hardware or firmware logic processors configured to execute hardware or firmware instructions. Processors of the logic processor may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects may be run on different physical logic processors of various different machines.

Non-volatile storage device 1906 includes one or more physical devices configured to hold instructions executable by the logic processors to implement the methods and processes described herein. When such methods and processes are implemented, the state of non-volatile storage device 1906 may be transformed—e.g., to hold different data.

Non-volatile storage device 1906 may include physical devices that are removable and/or built-in. Non-volatile storage device 1906 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 1906 may include nonvolatile, dynamic, static, read/write, read-only, sequential-access, location-addressable, file-addressable, and/or content-addressable devices. It will be appreciated that non-volatile storage device 1906 is configured to hold instructions even when power is cut to the non-volatile storage device 1906.

Volatile memory 1904 may include physical devices that include random access memory. Volatile memory 1904 is typically utilized by logic processor 1902 to temporarily store information during processing of software instructions. It will be appreciated that volatile memory 1904 typically does not continue to store instructions when power is cut to the volatile memory 1904.

Aspects of logic processor 1902, volatile memory 1904, and non-volatile storage device 1906 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program” may be used to describe an aspect of computing system 1900 typically implemented in software by a processor to perform a particular function using portions of volatile memory, which function involves transformative processing that specially configures the processor to perform the function. Thus, a program may be instantiated via logic processor 1902 executing instructions held by non-volatile storage device 1906, using portions of volatile memory 1904. It will be understood that different programs may be instantiated from the same application, service, code block, object, library, routine, API, function, etc. Likewise, the same program may be instantiated by different applications, services, code blocks, objects, routines, APIs, functions, etc. The term “program” may encompass individual or groups of executable files, data files, libraries, drivers, scripts, database records, etc.

When included, display subsystem 1908 may be used to present a visual representation of data held by non-volatile storage device 1906. This visual representation may take the form of a graphical user interface (GUI). As the herein described methods and processes change the data held by the non-volatile storage device, and thus transform the state of the non-volatile storage device, the state of display subsystem 1908 may likewise be transformed to visually represent changes in the underlying data. Display subsystem 1908 may include one or more display devices utilizing virtually any type of technology; however, one utilizing a microelectromechanical system (MEMS) projector to direct laser light may be compatible with the eye-tracking system in a compact manner. Such display devices may be combined with logic processor 1902, volatile memory 1904, and/or non-volatile storage device 1906 in a shared enclosure, or such display devices may be peripheral display devices.

When included, input subsystem 1910 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1912 may be configured to communicatively couple various computing devices described herein with each other, and with other devices. Communication subsystem 1912 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1900 to send and/or receive messages to and/or from other devices via a network such as the Internet.

Various exemplary embodiments of the present microlenses providing wide range chief ray angle manipulation for a panel display are now presented by way of illustration and not as an exhaustive list of all embodiments. An example includes a display engine adapted for use with a head-mounted display (HMD) device configured to display images of virtual objects, comprising: a panel display configured with a plurality of sources for generating rays of light forming pixels for a virtual image display, the virtual image display having a central axis projecting from a plane of the virtual image display; and a microlens array disposed in the display engine proximate to the panel display, each microlens in the array respectively corresponding to a pixel from the sources, and each microlens configured to manipulate a light ray for a respective corresponding pixel to match the light ray's chief ray angle, wherein the microlens array includes a plurality of different microlens configurations in which a microlens configuration is based on its distance from the central axis so that greater light ray manipulation is performed by microlenses for pixels closer to the central axis relative to light ray manipulation that is performed by microlenses for pixels more distant from the central axis, and wherein the different microlens configurations comprise a circularly symmetric surface, an asymmetric freeform surface, and a spatial offset with a corresponding pixel.

In another example, the light sources comprise one of light-emitting diode (LED), organic light-emitting diode (OLED), microLED, miniLED, quantum-dot light-emitting diode (QLED), or emissive source. In another example, the display engine further comprises an optical projection system adapted for providing the display of virtual images for delivery to at least one eye of an HMD device user. In another example, the microlens array is divided into a plurality of co-axial regions arranged around a central axis of the microlens array and microlenses in each region are similarly configured. In another example, a microlens for a pixel having an off-axial location to the central axis is configured with a freeform surface shape and is also spatially offset from its respective corresponding pixel. In another example, a varying amount of spatial offset is implemented for microlenses in which the variation is calculated using linear interpolation between respective spatial offset values for a microlens located proximate to a central axis of the microlens array and a microlens located distal from the central axis. In another example, a microlens for a pixel that is located nearer to the central axis relative to the off-axial pixel is configured with a circularly symmetric surface. In another example, the pixels comprise a plurality of sub-pixels that correspond to colors in a color model. In another example, the display engine is adapted for use with one of a virtual-reality display system or a mixed-reality display system.

A further example includes a head-mounted display (HMD) device wearable by a user and supporting a mixed-reality experience including viewing virtual images from a virtual world, comprising: an emissive display that is arranged as a planar panel and configured to provide an array of pixels forming the virtual images, the planar panel being described using an X, Y, Z coordinate system in which pixels extend in X and Y directions in an XY plane and a central axis of the planar panel extends in a Z direction; and an array of microlenses that is disposed over the planar panel in the Z direction in which each microlens in the array is configured to shape light rays for a respective corresponding pixel in the pixel array, wherein microlenses located in the XY plane away from the central axis have exit surfaces shaped differently from microlenses located in the XY plane towards the central axis, and wherein microlenses located in the XY plane away from the central axis are spatially offset in the XY plane from their respective corresponding pixels in the pixel array.

In another example, microlenses located in the XY plane away from the central axis have asymmetric freeform exit surfaces. In another example, the asymmetric freeform exit surfaces and the spatial offset of the microlenses provide manipulation of light rays from respective corresponding pixels to match a chief ray angle of the light rays. In another example, a microlens located in the XY plane away from the central axis is tilted on the XY plane to provide collimation of light rays from a respective corresponding pixel to match a chief ray angle of the light rays. In another example, microlenses located in the XY plane towards the central axis have circularly symmetric exit surfaces. In another example, the HMD device further comprises an optical projection system configured to receive light rays exiting the microlens array and project the virtual images. In another example, the HMD device further comprises an optical combiner configured to combine the virtual images from the optical projection system with light from real-world objects in a mixed-reality display. In another example, the optical combiner further includes an input coupler to receive the virtual images from the optical projection system and an output coupler to deliver the virtual images to an eye of the user.

A further example includes a method for operating an optical display system to display virtual images within a field of view (FOV) of a head-mounted display (HMD) device, comprising: utilizing an emissive panel display for generating an array of pixels that form the virtual images, the panel display having a central axis that projects in a direction of emission of light rays from the panel display, wherein the pixel array comprises on-axial pixels relative to the central axis and off-axial pixels relative to the central axis; providing an array of microlenses that is disposed over the panel display in which each microlens in the array corresponds to a respective pixel in the pixel array that forms the virtual images; and configuring the microlenses in the array to tune light rays for each of the off-axial pixels to a chief ray angle associated with the light rays to have substantially similar brightness as the on-axial pixels within the FOV of the HMD device.

In another example, the tuning comprises configuring a microlens with a freeform surface shape described by one of an extended polynomial or a direct calculation based on imaging theory. In another example, the tuning further comprises configuring the microlens having a freeform surface shape with a spatial offset to its corresponding pixel in a plane of the panel display.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A display engine adapted for use with a head-mounted display (HMD) device configured to display images of virtual objects, comprising:
a panel display configured with a plurality of sources for generating rays of light forming pixels for a virtual image display, the virtual image display having a central axis projecting from a plane of the virtual image display; and
a microlens array disposed in the display engine proximate to the panel display, each microlens in the array respectively corresponding to a pixel from the sources, and each microlens configured to manipulate a light ray for a respective corresponding pixel to match the light ray's chief ray angle,
wherein the microlens array includes a plurality of different microlens configurations in which a microlens configuration is based on its distance from the central axis so that greater light ray manipulation is performed by microlenses for pixels closer to the central axis relative to light ray manipulation that is performed by microlenses for pixels more distant from the central axis, and
wherein the different microlens configurations comprise a circularly symmetric surface, an asymmetric freeform surface, and a spatial offset with a corresponding pixel.

2. The display engine of claim 1 in which the light sources comprise one of light-emitting diode (LED), organic light-emitting diode (OLED), microLED, miniLED, quantum-dot light-emitting diode (QLED), or emissive source.

3. The display engine of claim 1 further comprising an optical projection system adapted for providing the display of virtual images for delivery to at least one eye of an HMD device user.

4. The display engine of claim 1 in which the microlens array is divided into a plurality of co-axial regions arranged around a central axis of the microlens array and microlenses in each region are similarly configured.

5. The display engine of claim 1 in which a microlens for a pixel having an off-axial location to the central axis is configured with a freeform surface shape and is also spatially offset from its respective corresponding pixel.

6. The display engine of claim 1 in which a varying amount of spatial offset is implemented for microlenses in which the variation is calculated using linear interpolation between respective spatial offset values for a microlens located proximate to a central axis of the microlens array and a microlens located distal from the central axis.

7. The display engine of claim 6 in which a microlens for a pixel that is located nearer to the central axis relative to the off-axial pixel is configured with a circularly symmetric surface.

8. The display engine of claim 1 in which the pixels comprise a plurality of sub-pixels that correspond to colors in a color model.

9. The display engine of claim 1 as adapted for use with one of a virtual-reality display system or a mixed-reality display system.

10. A head-mounted display (HMD) device wearable by a user and supporting a mixed-reality experience including viewing virtual images from a virtual world, comprising:
an emissive display that is arranged as a planar panel and configured to provide an array of pixels forming the virtual images, the planar panel being described using an X, Y, Z coordinate system in which pixels extend in X and Y directions in an XY plane and a central axis of the planar panel extends in a Z direction; and
an array of microlenses that is disposed over the planar panel in the Z direction in which each microlens in the array is configured to shape light rays for a respective corresponding pixel in the pixel array,
wherein microlenses located in the XY plane away from the central axis have exit surfaces shaped differently from microlenses located in the XY plane towards the central axis, and
wherein microlenses located in the XY plane away from the central axis are spatially offset in the XY plane from their respective corresponding pixels in the pixel array.

11. The HMD device of claim 10 in which microlenses located in the XY plane away from the central axis have asymmetric freeform exit surfaces.

12. The HMD device of claim 11 in which the asymmetric freeform exit surfaces and the spatial offset of the microlenses provide manipulation of light rays from respective corresponding pixels to match a chief ray angle of the light rays.

13. The HMD device of claim 10 in which a microlens located in the XY plane away from the central axis is tilted on the XY plane to provide collimation of light rays from a respective corresponding pixel to match a chief ray angle of the light rays.

14. The HMD device of claim 10 in which microlenses located in the XY plane towards the central axis have circularly symmetric exit surfaces.

15. The HMD device of claim 10 further comprising an optical projection system configured to receive light rays exiting the microlens array and project the virtual images.

16. The HMD device of claim 15 further comprising an optical combiner configured to combine the virtual images from the optical projection system with light from real-world objects in a mixed-reality display.

17. The HMD device of claim 16 in which the optical combiner further includes an input coupler to receive the virtual images from the optical projection system and an output coupler to deliver the virtual images to an eye of the user.

18. A method for operating an optical display system to display virtual images within a field of view (FOV) of a head-mounted display (HMD) device, comprising:
utilizing an emissive panel display for generating an array of pixels that form the virtual images, the panel display having a central axis that projects in a direction of emission of light rays from the panel display, wherein the pixel array comprises on-axial pixels relative to the central axis and off-axial pixels relative to the central axis;
providing an array of microlenses that is disposed over the panel display in which each microlens in the array corresponds to a respective pixel in the pixel array that forms the virtual images; and
configuring the microlenses in the array to tune light rays for each of the off-axial pixels to a chief ray angle associated with the light rays to have substantially similar brightness as the on-axial pixels within the FOV of the HMD device.

19. The method of claim 18 in which the tuning comprises configuring a microlens with a freeform surface shape described by one of an extended polynomial or a direct calculation based on imaging theory.

20. The method of claim 19 in which the tuning further comprises configuring the microlens having a freeform surface shape with a spatial offset to its corresponding pixel in a plane of the panel display.
